(19) United States
(12) Patent Application Publication
(10) Pub. No.: US 2013/0262267 A1
(43) Pub. Date: Oct. 3, 2013

(54) SMS MESSAGING METHODS AND SYSTEMS HAVING INTERACTIVE FUNCTIONALITIES FOR INCREASING COMMERCIAL TRAFFIC TO ENTERPRISES AND FOR GATHERING DATA USEFUL FOR COMMERCIAL ACTIVITIES

(71) Applicants: Dillon TAYLOR, Pleasant Hill, CA (US); Gerogia TAYLOR, Pleasant Hill, CA (US); David TAYLOR, Pleasant Hill, CA (US)

(72) Inventors: Dillon TAYLOR, Pleasant Hill, CA (US); Gerogia TAYLOR, Pleasant Hill, CA (US); David TAYLOR, Pleasant Hill, CA (US)

(21) Appl. No.: 13/864,818

(22) Filed: Apr. 17, 2013

Related U.S. Application Data
(62) Division of application No. 13/711,580, filed on Dec. 11, 2012.
(60) Provisional application No. 61/630,627, filed on Dec. 15, 2011.
(60) Provisional application No. 61/685,296, filed on Mar. 15, 2012.

(51) Int. Cl. G06Q 30/06; H04W 4/14

(52) U.S. Cl. CPC G06Q 30/0613; H04W 4/14
USPC 705/26.41

(57) ABSTRACT

SMS-based communications methods and systems comprising interactive functionalities, as well as devices, software, modules and integrated systems and methods are provided. The text-messaging methods and systems of the invention are particularly useful for increasing the marketability of products and services, and for increasing commercial traffic to one or more commercial establishments through network communicated dialogues and other communications. SMS-based systems and methods of the invention are configured also to be able gather and analyze many different kinds and patterns of data, such as that relating to marketing and advertising activities, and to performance of the systems and methods themselves. The present technology relates also to methods and systems for both gathering and using marketing and other commercial information on a real time basis to increase enterprise incoming traffic flow and business. Methods and systems of the invention can be provided in turnkey forms, and can also configured for particular enterprises, and also by means of one or more modules, for example, provided on a digital device such as a server.

### RELATED APPLICATIONS

This Track-One Patent Application is a Continuation Application of U.S. utility patent application Ser. No. 13/711,580, filed 11 Dec. 2012, and claims priority to U.S. Provisional Patent Application Ser. No. 61/630,427, entitled “Text Messaging Response Systems, Methods, Devices, Modules, Software And Business Methods”, as filed 12 Dec. 2011 under Attorney Ref. No. 21344-611515. This Patent Application further claims priority to U.S. Provisional Patent Application Ser. No. 61/685,296, entitled “Communications Methods, Systems And Business Methods For Increasing Commercial Traffic And Marketing Affected Primarily Via SMS Systems, And For Gathering Marketing And Other Data Via SMS-Facilitated Dialogue And Analytic Systems”, as filed 12 Dec. 2011 under Attorney Reef. No. 21344-925303. The content and spirit of all of the recited Patent Applications are hereby incorporated in the present application. Moreover, Applicants qualify for Micro Entity status regarding USPTO fees.

### FIELD OF THE TECHNOLOGY

The disclosed technology relates to communications systems, methods, business methods, devices, software, modules and integrated systems and methods adapted and arranged for using text messaging and other modalities to immediately obtain one or a plurality of responses to certain types of digital inquiries made by a customer or potential customer with respect to a commercial or other establishment. The technology relates also to methods and systems for gathering marketing and other commercial information on a real time basis, and for analyzing and mining that information on a variety of different bases.

### BACKGROUND

Currently, customers of retail and other stores and commercial establishments wanting to obtain information about store hours, items on sale, and product availability without going to a store must make a phone call or go to the store's company website.

When a potential customer makes an inquiry by a phone call or by accessing a website, these actions usually results in one or more of being put on telephonic hold, navigating through a telephonic voice response unit, or searching through a website to obtain an answer to the potential customer's question.

These scenarios are out of the question for people that are, for example, on a tight schedule, riding in a motor vehicle or other machinery, in a business meeting, attending a class, or otherwise occupied.

Global Smartphone volume in the fourth quarter of 2012 (4Q12) is expected to reach 224.5 million units, representing 39.5% year-over-year growth due primarily to strong consumer demand. According to the International Data Corporation (IDC) Worldwide Quarterly Mobile Phone Tracker, Smartphone shipments for 2012 are forecasted to grow 45.1% year over year to 717.5 million units

The fast-growing Smartphone market, which will grow more than four times the rate of the overall mobile phone market this year, is being fuelled by falling average selling prices, increased phone functionality, and lower-cost data plans among other factors, which make the devices more accessible to a wider range of users.

This trend is important for the use of the present Text Message Response System (TMRS) because it relies on the cell phone user having a Smartphone, PC or other computer-type device that is adapted and arranged to enable the user to easily access a company website in order to obtain the text address for receipt of a text message inquiry sent by the user. That text address can be either a mobile phone number or a Universal Resource Locator (URL). A more basic cell phone that can send text messages can still access the system, but the user must first find the address by using a PC, laptop, tablet or other published address resource.

### SUMMARY

The present invention provides systems, methods, modules, software and business methods adapted and arranged for using the text messaging functionalities of electronic devices in order to provide platforms for immediately respond to certain types of text message inquiries made by a potential customer, and for conducting real time dialogue between a potential customer and one or more commercial entities. The invention provides also means and methods for recording, analyzing and evaluating the inquiry/response dialogues to gamer marketing and preference information, and for immediately evaluating the effects of the various dialogues with respect to the sales and popularity of categories of products, specific products, competitive products, and many other parameters of marketing, sales and product promotion.

In this and related communications and marketing contexts, the present invention provides heretofore unavailable functionality targeted at supporting existing business processes, such as those pertaining to sales, marketing and customer relationship management and promotion.

In some embodiments, the present Text Message Response System invention utilizes the functionalities of Short Message Service (SMS) technology for affecting the submission of questions within the present system, and the transmittal of responses to those questions. In general, Short Message Services are systems and methods of communication that transmit text between and among cell phones, or between and among other digital devices, such as PC's handheld devices and mobile phones. The “Short” (“S”) part of the SMS acronym refers to the maximum size that can be transmitted and received in such systems. Generally, the maximum size of text messages in such systems is 160 characters (comprising letters, numbers or symbols in an appropriate alphabet).

It is thus an object of the invention to provide methods, means, systems, software modules and communications methods for facilitating real time and other communications between commercial establishments and potential customers.

It is another object of the invention to provide business methods for increasing customer traffic to specific commercial entities and to increase sales and marketing activities for specific commercial entities with respect to various types and categories of products being offered.

In accordance with these and other objects of the invention, a plurality of methods, systems and technologies are provided. In significant aspects, methods for one or more of increasing the marketability of products and/or for increasing commercial traffic to one or more commercial establishments, is provided. In some embodiments, the method comprises the steps or actions of A) providing a Short Messaging Service (SMS) system adapted and arranged for receiving and responding to one or more text message inquiries from a sender to one or more commercial businesses regarding one or more products, the inquiries sent via the sender's electronic device, wherein the SMS system is adapted and arranged to reply to the one or more inquiries by affecting responses to each inquiry regarding the products of the one or more businesses, and wherein the SMS system is adapted and arranged to record at least some of the inquiries and responses to provide one or more databases of i) collected inquiries, and ii) collected responses, and iii) combined collected inquiries and response; and then, B) performing one or more analyses with respect to at least a portion of the collected inquiries and collected responses to obtain one or more categories of useful data sets.

According to certain advantages of the invention, the method comprises wherein one or more of Steps or Actions A and B are affected in real time. In accordance with other advantages of the invention, the method comprises wherein responses to the inquiries are at least partially determined by the results of the one or more analyses of Step B.

As another advantage, methods of the invention may comprise wherein the one or more analyses of Step B pertain to determining the marketability of one or more products by tracking the interest expressed by potential consumers of those products via the SMS system, and further wherein the one or more analyses of Step B are adapted and arranged to affect one or more of a) accruing marketability information with respect to one or more products and b) affecting a negotiation dialogue with the sender. Advantageously, the methods of the invention can be adapted and arranged such that the one or more categories of useful data sets are one or more selected from the group comprising the electronic device identifier number, the type of inquiry made, the number of responses in an inquiry/response dialogue, the number of responses in an inquiry/response dialogue with respect to time, the class of products referenced in the inquiry, the specific product referenced in the inquiry, the result of the inquiry (purchase or not, hold or not, further inquiry or not), and any other class, group or category of data sets.

As yet another advantage, the present methods include wherein one or more of Steps A and B are affected by the steps or actions of C, providing at least one server, wherein the at least one server is adapted and arranged to receive and respond to the text message inquiries via a website, the server comprising at least one Response Database and at least one Inventory Database, the server comprising data adapted and arranged to provide at least one Response to the text message inquiries, and D, providing an affected response to the text message inquiry from the sender, wherein the affected response is provided via at least one communications network to the sender's electronic device.

The present methods may include or further comprise the step of E, engaging in a sales negotiation by conducting a dialogue with a potential customer with respect to a product designated by an inquiry from that customer via an SMS system, wherein the dialogue occurs between the potential customer and a computer-facilitated entity.

Additionally, the methods of the invention may include or further comprise the step of F, accruing marketability information with respect to one or more products by providing an SMS system adapted and arranged to respond to product availability inquiries and product pricing inquiries, and then analyzing the information gathered by that system with respect to those products. Similarly, the present methods may include or further comprise the step of G, adjusting the price and availability of one or more products by providing an SMS system adapted and arranged to respond to product availability and pricing inquiries via SMS messages, and then analyzing the information gathered by that system with respect to changing one or more of the price and the availability of those products.

In another advantageous aspect, the instant means and methods may include or further comprise the step of H, increasing the interest in one or more products, or one or more commercial establishments, by advertising the availability of one or more products via conventional means, and then encouraging inquiries via one or more SMS systems adapted and arranged to provide information about those products and establishments. In a similar adaptation of the present invention, some embodiments of the present methods may include or further comprise the step of I, providing one or more new communications channels between potential customers and one or more business or commercial entities facilitated via one or more SMS systems.

In further embodiments of the invention, the methods may include or further comprise the step or action of providing one or more of an integrated circuit or digital storage device having adapted and arranged thereon software means for affecting some or all of the aspects of the present SMS technology. Included in the invention are thus embodiments where one or more specific commercial subscribers to a method or system of the invention can distribute, via some form of digital media, such as an SD card, USB device or other digital transfer, one or more specific embodiments of the invention which include software for practicing the invention generally as well as specific portions of software adapted and arranged such that the invention is particularly advantageous to one or more specific commercial establishment. Exemplary of specific commercial establishments are big box stores, restaurant chains and electronics stores.

The invention includes also a plurality of methods and means for disseminating the invention itself, thereby amplifying both the affect and the effectiveness of the invention. As examples, the methods of the invention may further include or comprise the step of broadcasting in a commercial location software means, for example via Wi-Fi, for practicing the invention, wherein the customer can opt in or opt out of various features of the invention, wherein opting in is rewarded or incentivized with a digital discount coupon or supplementary offer. The invention may also include, comprise, or provide the step of providing one or more digital devices, such as SD cards or USB devices adapted for practicing at least a portion of the SMS invention as described herein, and then distributing those one or more devices to potential users or customers in either an incentivized or neutral offering.

As examples, the present methods and systems include wherein the step of providing a “bonus card chip” somewhat like a supermarket shoppers discount card or phone download, wherein the bonus chip card has at least one operational portion of at least one embodiment of the invention on the chip. Moreover, the present systems and methods include a step of providing a downloadable phone or handheld digital device comprising at least one operational portion of software adapted and arranged for enabling on the phone or device at least one embodiment of the invention on the provided chip.

As yet an additional set of advantages, the present methods, systems for increasing the flow of customer traffic to one or more enterprises may include or comprise steps or actions for providing at least one server, wherein the at least one server is operatively connected to at least one website, and wherein the at least one server is adapted and arranged to receive and respond to a plurality of text message inquiries via the website, the server comprising at least one Response Database and at least one Inventory Database, the server further comprising data adapted and arranged to provide at least one Response to each of the one or more text message inquiries, and providing an affected response to the one or more text message inquiries from the one or more senders, wherein the affected response is provided via at least one second communications network to the sender's electronic device.

Included in the invention are embodiments where a specific commercial subscriber to a method or system of the invention can distribute, via some form of digital media, such as an SD card, specific embodiments of the invention which include software for practicing the invention generally as well as specific portions of software adapted and arranged such that the invention is particularly advantageous to one or more specific commercial establishment. Exemplary of specific commercial establishments are big box stores, restaurant chains and electronics stores.

In another set of advantageous embodiments of the invention, one or more software applications are provided which enable users to quickly learn about, and utilize, many of the aspects of the invention. As an example, a downloadable phone software application can be provided, wherein the software app has a guide on how to use the invention, including, e.g., what questions, by industry, which can be posed to the invention to obtain useful or promotional information. Such applications may also include links to particular commercial establishments, such as discount stores, big box stores and restaurants or to other entities that can benefit by the invention. Such software applications may be provided, for example, via the Internet, wirelessly, on thumb drives, disc media, or by any other means adaptable for using any embodiments of the invention.

As soon as one or more of the software applications are installed on a digital device, the user can view the commercial establishments that currently have the text response capability enabled by the invention. With each listed company can be provided at least one e:address where messages can be sent, and dialogues initiated. Exemplary of one of the embodiments of the invention is that wherein a simple question is posed via an inquiry sent, for example, by a Smartphone.

Textual Example of How to Use One Embodiment of The Invention to Send a Text Message Utilizing a Typical Software Application in Accordance With the Invention:

In the software application, select the desired commercial establishment and press
“Send Message”.
Enter your question.
Press “Send”.

As another advantageous aspect of the invention, users of the present systems will be provided with one or more opportunities to receive notifications of product promotions and specials. If they change their mind, the users can merely respond to the notification with a request to unsubscribe.

Examples of product promotions and specials include new product releases (“The iPhone 6 is now available! Reserve 1 now for immediate pickup!”), real time incentive offers (“Buy within 10 mins and receive 15% off!—Pick up w/in 2 days!”), combined purchase offers (“Buy both a wireless modem and a PC to receive a 15% discount today only!”) and one-time offers (“Clearance on Smartphone Computer Combinations 24 Hrs only!”).

Moreover, as an additional advantage, the invention provides digital abbreviations adapted and arranged for rendering the dialogues of the invention, and other dialogues, at an even more efficient rate, for example, by reducing the number of keystrokes necessary to formulate specific inquiries.

In accordance with the many other possible permutations and corresponding advantages of the invention, the Response and Inquiry databases can be product-specific, and marketing-specific, data stores that can be stored on, and accessed from, one or more servers, such as from physically separate servers, or from separate servers. Advantageously, this is one of a number of choices that is given to the enterprise when configuring the invention for production use. Additionally, the Inventory database can be the operational data store currently used by the enterprise in its daily operations. Thus, an ongoing enterprise can utilize its existing databases by operably connecting them to one or more of the systems of the invention, for example, during configuration or implementation.

The present invention also comprises providing software or firmware adapted and arranged to affect any of the systems or steps described herein on one or more integrated circuits (chips) comprising software adapted and arranged to affect any portions or all of the present invention.

### BRIEF DESCRIPTION OF THE DRAWINGS

FIG. 1 shows graphically a typical simple question and response sequence from a typical hand-held device, such as a mobile phone, that can be facilitated by the present invention.

FIG. 2 shows graphically the question and response sequence of FIG. 1, including a follow-on response from a hand-held device, such as a mobile phone.

FIG. 3 shows graphically a typical simple question and response sequence from a Personal Computer, laptop or tablet device that can be facilitated by the present invention.

FIG. 4 shows graphically the question and response sequence of FIG. 3, including a follow-on response from a Personal Computer, laptop or tablet device.

FIG. 5 is a swim lane diagram showing some of the typical interrelationships among the various significant elements in the Text Message Response Systems of the invention.

FIG. 6 is a table showing some of the typical variations of a typical text message inquiry, and some possible responses to that inquiry from a typical Sample Response Data Base according to the invention.

FIG. 7 is a swim lane diagram showing some of the typical interrelationships among the various elements of the Product Notification Subscription Systems of the invention.

FIG. 8 is a swim lane diagram showing some of the typical interrelationships among the various elements of the Response Management Systems of the invention.

FIG. 9 is a graph depicting some typical patterns of inventory and sales activity for a typical product (an Apple iPad) whose marketing and sales can be advanced by various permutations of the invention.

FIG. 10 shows graphically a sample inquiry and response dialogue adapted and arranged to close a sale with the potential customer as facilitated by the present invention.

FIG. 11 shows graphically an alternative inquiry and response dialogue to close a sale with the same potential customer of FIG. 10.

FIG. 12 is a graph depicting the affect of use of the present invention on patterns of customer inquiries and sales activity following mass media advertising for a product.

FIG. 13 is a table containing a representative sample, by industry, of some of the possible customer inquiries and follow-up questions included with responses that can be facilitated by the invention.

### DETAILED DESCRIPTION OF THE INVENTION

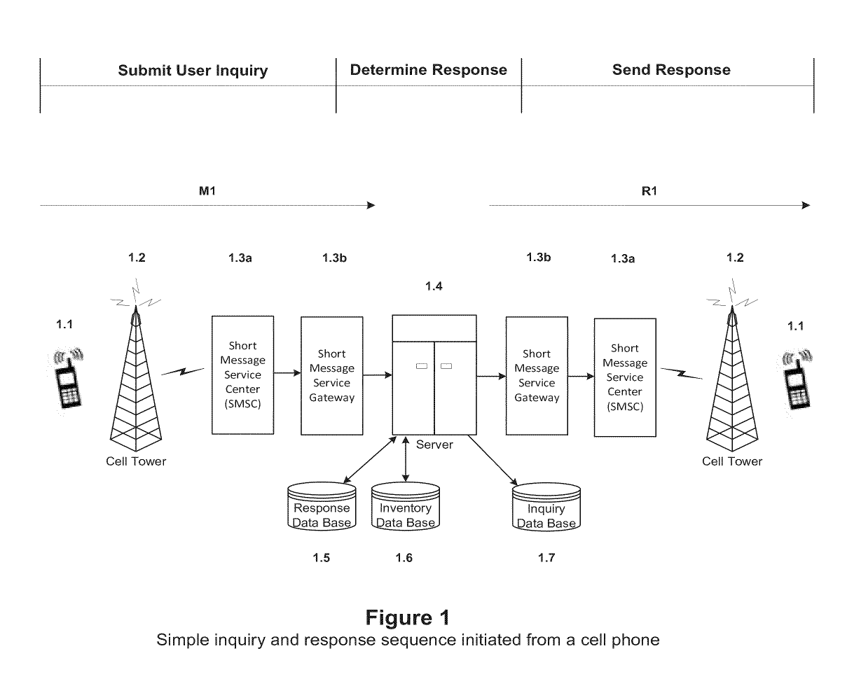

Examples of various embodiments of the invention will now be described with respect to the attached figures. FIG. 1 shows a typical simple question and response sequence from a hand-held device, such as a mobile phone, that can be facilitated by the present invention. With respect to FIG. 1, Text Message M1, comprising Contents C (“M1(C))” is sent from Handheld Device 1.1, such as a cell phone, to Cell Tower 1.2. Cell Tower 1.2 then relays M1 by way of Short Message Service Center 1.3a and Short Message Service Gateway 1.3b to Web Server 1.4. Web Server 1.4 is provided in operative connection to all of Response Data Base 1.5, Inventory Database 1.6, and Inquiry Database 1.7. Web Server 1.4 is adapted and arranged to operatively communicate with Response Data Base 1.5, Inventory Database 1.6, and Inquiry Database 1.7 to affect the purposes and ends of the invention.

Web Server 1.4 is provided with Key Data D regarding one or multiple Participating Enterprises. Key Data D for one or more Participating Enterprises, comprises, for example, store hours, store inventory, featured or sale products, rebate information and offers, discount information and offers, special offers, backorder information, product availability dates, and new release push advertising information.

Upon receipt of Text Message M1, Web Server 1.4 processes Text Message M1. In some embodiments of the invention, each Text Message M, or Selected Text Messages (STM's), can each have a unique Identifier. In other embodiments, Selected Message Groups (SMG's) can each have a Unique Group Identifier (UGI). As examples, collections of Identifiers IC (or from In to In+1) can be used, for example, as marketing or communications research tools by the commercial establishments, or by third parties monitoring and industry, for example, or monitoring the performance of the invention itself.

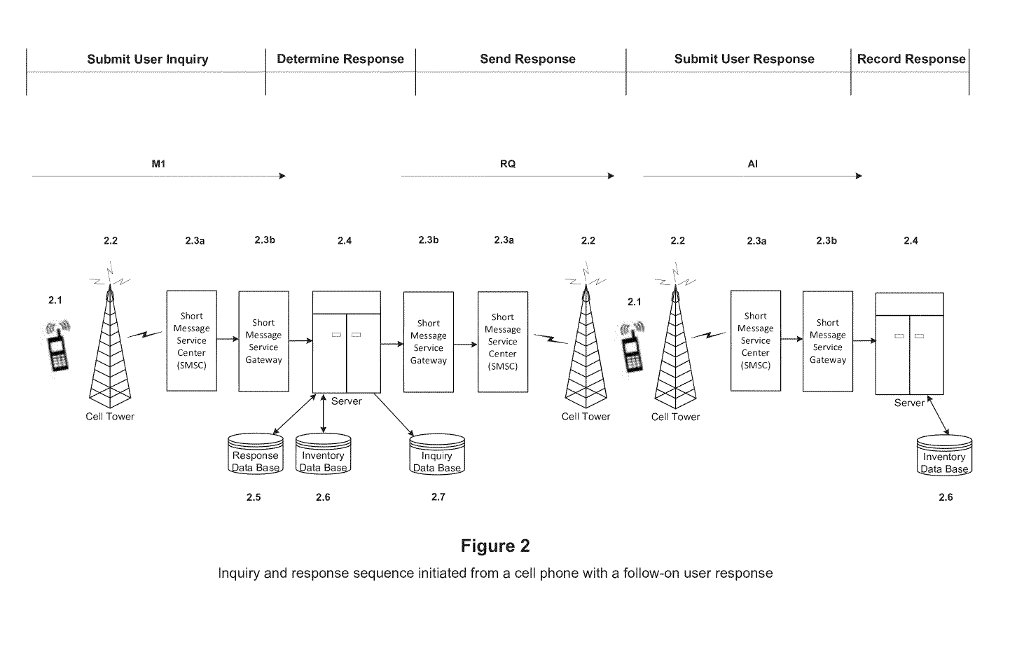

The receipt of M1 by Web Server 1.4 triggers the accessing of Response Database 1.5 and the matching of Text Message M1's Content C (“M1(C))” against information Q in Response Database 1.5. Response Database 1.5 contains, in a significant aspect, answers or responses to many customer questions contained within Content C of Message M1. If Text Message M1 comprising includes Contents C (“M1(C))” a question pertaining to product availability or sale items, Inventory Database 1.6 is also queried by Web Server 1.4 to access the product information contained in Database 1.6. Web Server 1.4 is adapted and arranged to also communicate with Inventory Database 1.6 to affect the purposes and ends of the invention, as is shown further in FIG. 2. In some key embodiments of the invention, Text Message M1, along with an identifier of the response given, is then stored in Inquiry Database 1.7. After accessing the several databases in response to Text Message M1, Server 1.4 then sends Response R1 via Short Message Service Gateway 1.3b, Short Message Service Center 1.3a and cell tower 1.2, which communicates Text Message M1 to Handheld Device 1.1.

FIG. 2 shows the question and response sequence of FIG. 1, including a follow-on response from a hand-held device, such as a mobile phone. With respect to FIG. 2, Text Message M1, comprising Contents C (“M1(C))”, is sent from Handheld Device 2.1, such as a cell phone, to Cell Tower 2.2, and then M1 is sent through Short Message Service Center 2.3a and Short Message Service Gateway 2.3b to Web Server 2.4. Web Server 2.4 is provided in operative connection to Response Data Base 2.5, Inventory Database 2.6, and Inquiry Database 2.7. Web Server 2.4 is adapted and arranged to operatively communicate with Response Data Base 2.5, Inventory Database 2.6, and Inquiry Database 2.7 to affect the purposes and ends of the invention.

Web Server 2.4 is provided with Key Data D regarding one or multiple Participating Enterprises. Key Data D for one or more Participating Enterprises comprises, for example, store hours, store inventory, featured or sale products, rebate information and offers, discount information and offers, special offers, backorder information, product availability dates, and new release push advertising information.

Upon receipt of Text Message M1, Web Server 2.4 processes Text M1 by accessing Response Database 2.5 and attempting to match Text Message M1's Content C against information Q in Response Database 2.5. Response Database 2.5 contains a variety of possible answers or responses to many customer questions contained within Content C of Message Ml. When a match is made, Web Server 2.4 queries Cell Phone 2.1 with Query Z via Short Message Service Gateway 2.3b, Short Message Service Center 2.3a and Cell Tower 2.2 for additional information. As an example, Response RQ comprises the phrasing “do you want us to hold one for you?” If the sender so desires, he/she then sends additional information AI in response to RQ via Cell Tower 2.2, Short Message Service Center 2.3a and Short Message Service Gateway 2.3b to Web Server 2.4 to access Inventory Database 2.6. Text Message M1, along with an identifier of the response given, is then stored in Inquiry Database 2.7.

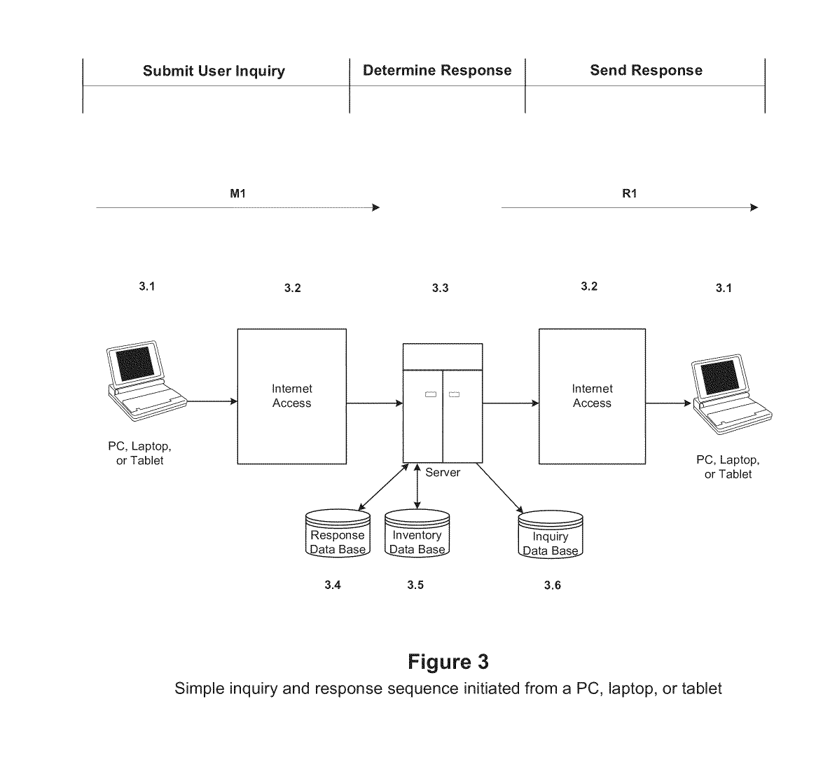

FIG. 3 shows a typical simple question and response sequence from a Personal Computer, laptop or tablet device that can be facilitated by the present invention. With respect to FIG. 3, Text Message M1, comprising Contents C, is sent from PC/Laptop/Tablet PC 3.1 via Internet Access 3.2, which is operably connected to, or connectable to, Web Server 3.3. Web Server 3.3 is provided in operative connection to Response Data Base 3.4, Inventory Database 3.5, and Inquiry Database 3.6. Web Server 3.3 is adapted and arranged to operatively communicate with Response Data Base 3.4, Inventory Database 3.5, and Inquiry Database 3.6 to affect the purposes and ends of the invention.

Web Server 3.3 is provided with Key Data D regarding one or multiple Participating Enterprises. Key Data D for one or more Participating Enterprises comprises, for example, store hours, store inventory, featured or sale products, rebate information and offers, discount information and offers, special offers, backorder information, product availability dates, and new release push advertising information.

Upon receipt of Text Message M1, Web Server 3.3 processes Text Message M1 by accessing Response Database 3.4 and matching Text Message M1's Content C against information Q in Response Database 3.4. Response Database 3.4 contains answers or responses to many customer questions contained within Content C of Message M1. If Text Message M1 comprising Contents C includes a question pertaining to product availability or sale items, Inventory Database 3.5 is also queried by Web Server 3.3 to access its product information. Web Server 3.3 is adapted and arranged to also communicate with Inventory Database 3.5 to affect the purposes and ends of the invention. Text Message M1, along with an identifier of the response given, is then stored in Inquiry Database 3.6.

After accessing the databases in response to Text Message M1, Server 3.3 then sends Response R1 via Internet Access 3.2, which communicates Text Message R1 to a PC, Laptop, or Tablet PC.

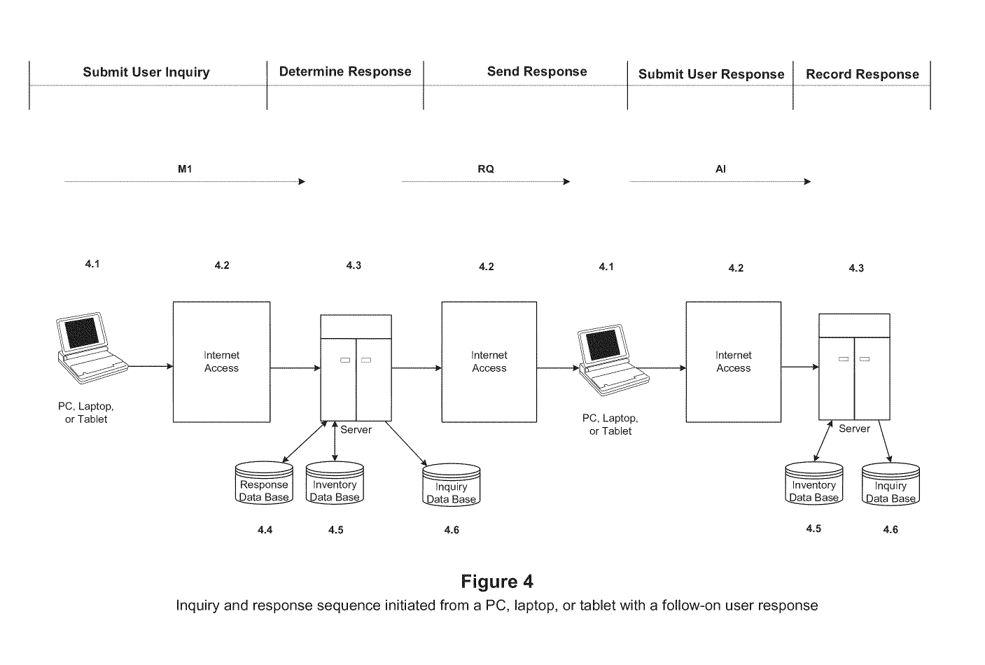

FIG. 4 shows the question and response sequence of FIG. 3, including a follow-on response from a Personal Computer, laptop or tablet device. With respect to FIG. 4, Text Message M1, comprising Contents C (“M1(C)),” is sent from PC/Laptop/Tablet PC 4.1 via Internet Access 4.2, which is operably connected, or operably connectable to, Web Server 4.3. Web Server 4.3 is provided in operative connection to Response Data Base 4.4, Inventory Database 4.5, and Inquiry Database 4.6. Web Server 4.3 is adapted and arranged to operatively communicate with Response Data Base 4.4, Inventory Database 4.5, and Inquiry Database 4.6 to affect the purposes and ends of the invention.

Web Server 4.3 is provided with Key Data D regarding one or multiple Participating Enterprises. Key Data D for one or more Participating Enterprises comprises, for example, store hours, store inventory, featured or sale products, rebate information and offers, discount information and offers, special offers, backorder information, product availability dates, and new release push advertising information.

Upon receipt of Text M1, Web Server 4.3 processes Text Message M1 by accessing Response Database 4.4 and matching Text Message M1's Content C against information Q in Response Database 4.4. Response Database 4.4 contains answers or responses to many customer questions contained within Content C of Message M1. If Text Message M1 comprising Contents C includes a question pertaining to product availability or sale items, Inventory Database 4.5 is also queried by Web Server 4.3 to access its product information. Web Server 4.3 is adapted and arranged to also communicate with Inventory Database 4.5 to affect the purposes and ends of the invention. Text Message M1, along with an identifier of the response given, is then stored in Inquiry Database 4.6.

When a match is made, Web Server 4.3 queries PC/Laptop/Tablet PC 4.1 via Internet Access 4.6, which is operably connected to, or operably connectable to, Web Server 4.3. If the sender so desires, in response to this query, he/she then sends additional information AI in response to the query via Internet Access 4.7 to Web Server 4.3 to access Inventory Database 4.5.

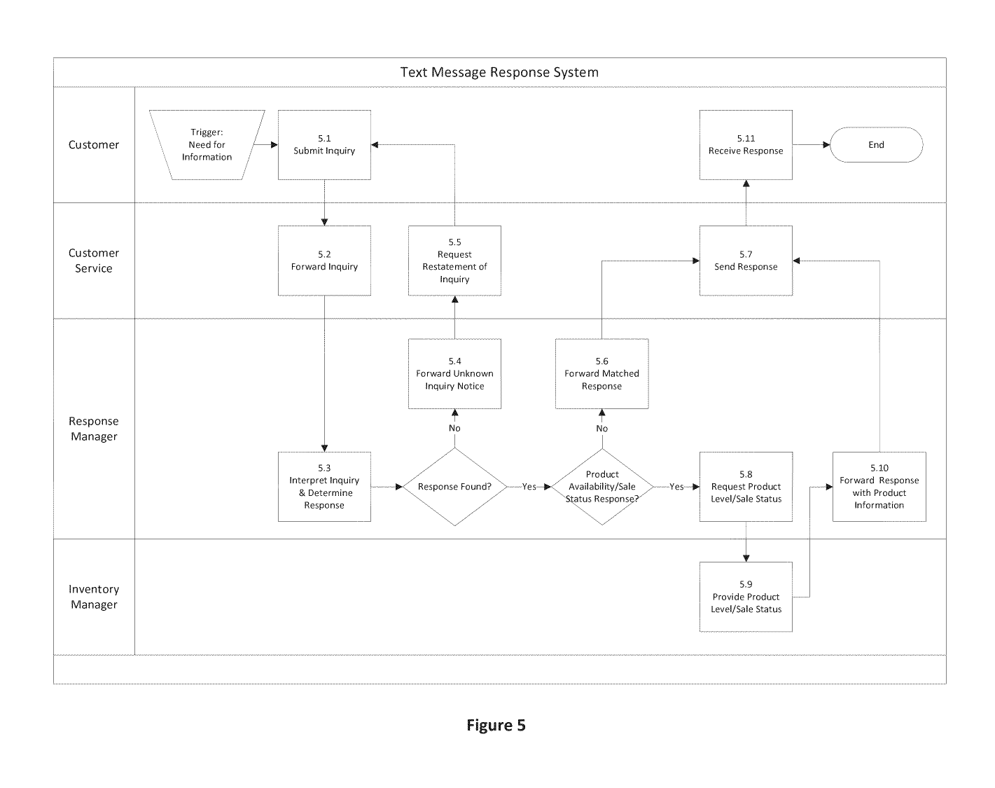

FIG. 5 is a swim lane diagram showing exemplary communications interrelationships between and among a Customer, the Customer Service functionality at a commercial establishment, the Response Manager functionality at the same commercial Establishment, and the Inventory Manager functionality at that same Commercial Establishment. With respect to FIG. 5, an Inquiry sent by the Customer in Activity 5.1 (Submit Response) is received by Activity 5.2 (Forward Inquiry) and sent on to Activity 5.3 (Interpret Inquiry & Determine Response). This activity examines the content of the Inquiry, ascertains whether a product request is included, and determines the correct Response to send to the customer. If no response is found, the Inquiry is forwarded by Activity 5.4 (Forward Unknown Inquiry Notice) to Activity 5.5 (Request Restatement of Inquiry). This activity transmits a Response, such as “We're sorry, but we are unable to interpret your question, would you please resend it?” or the like.

If an appropriate Response is found, and the Inquiry does not include a product request, Activity 5.6 (Forward Matched Response) appends the Response to the Inquiry and forwards it to Activity 5.7 (Send Response). This activity transmits the response to the Customer who gets the message in Activity 5.11 (Receive Response).

If an appropriate Response is found in the one or more Response Databases, and the Inquiry does include a product request, Activity 5.8 (Request Product Level/Sale Status) asks for product related information that is given by Activity 5.9 (Provide Product Level/Sale Status). Activity 5.10 (Forward Response with Product Information) appends the product data to the Response and sends it on for delivery by Activity 5.7 (Send Response). This activity transmits the completed message to the Customer who receives the Response in Activity 5.11 (Receive Response).

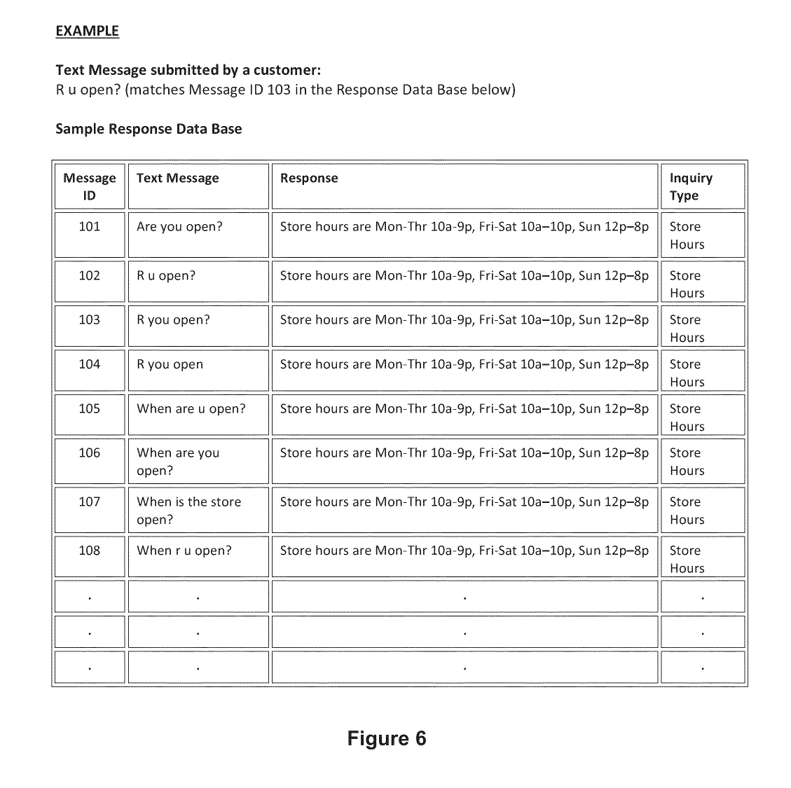

FIG. 6 shows some of the typical variations of an exemplary text message inquiry, and some possible responses to that inquiry from a typical Sample Response Data Base according to the invention. The Response Data Base is pre-populated with all of the conceivable ways that a question could be posed, including misspellings, abbreviations and combinations thereof. The Response Data Base is also revised and updated in accordance with the needs and desires of the users, the subscribers or the operators.

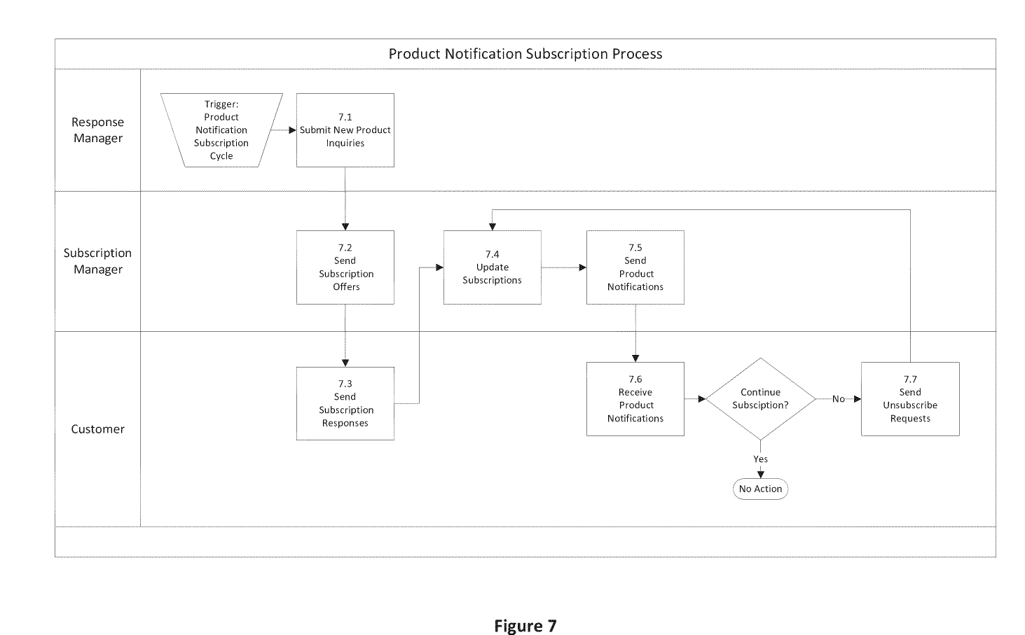

FIG. 7 is a swimlane diagram showing the communications interrelationships between and among a Customer, the Response Manager functionality at a commercial establishment, and the Subscription Manager functionality at the same commercial Establishment. With respect to FIG. 7, based on prior period Product Inquiries by the same customer, the Response Manager notifies the Subscription Manager in Activity 7.1 of those Inquiries. The Subscription Manager sends an offer to the customer inviting the customer to subscribe to one or more of product announcements, sales announcements, promotions, etc. to the Customer who made an inquiry in Activity 7.2. In Activity 7.3, the Customer then responds with their decisions and choices to the offers/invitations. Based on the customer's responses, the Subscription Manager updates the Subscriber records in Activity 7.4 which are used as a basis for any scheduled Notifications (of product announcements, sales announcements, promotions, etc.) sent in Activity 7.5.

The Customers who subscribe by responding to the invitations/offers received by them in the Notifications in Activity 7.6 and takes their preferred action in response to it. Upon receipt of the product notification, the Customer also has the option at this time to Unsubscribe to further Notifications. The customer can either take no action or send an Unsubscribe Request in Activity 7.7.

Examples of product promotions and specials which can be adapted and arranged for use with the invention include new product releases (“The iPhone 6 is now available! Reserve 1 now for immediate pickup!”), real time incentive offers (“Buy within 10 mins and receive 15% off!—Pick up w/in 2 days!”), combined purchase offers (“Buy both a wireless modem and a PC to receive a 15% discount today only!”) and one-time offers (“Clearance on Smartphone Computer Combinations 24 Hrs only!”).

As another advantageous aspect of the invention, users of the invention will be provided with one or more opportunities to receive notifications of product promotions and specials. If the users change their mind, they merely respond to the notification with a request to unsubscribe.

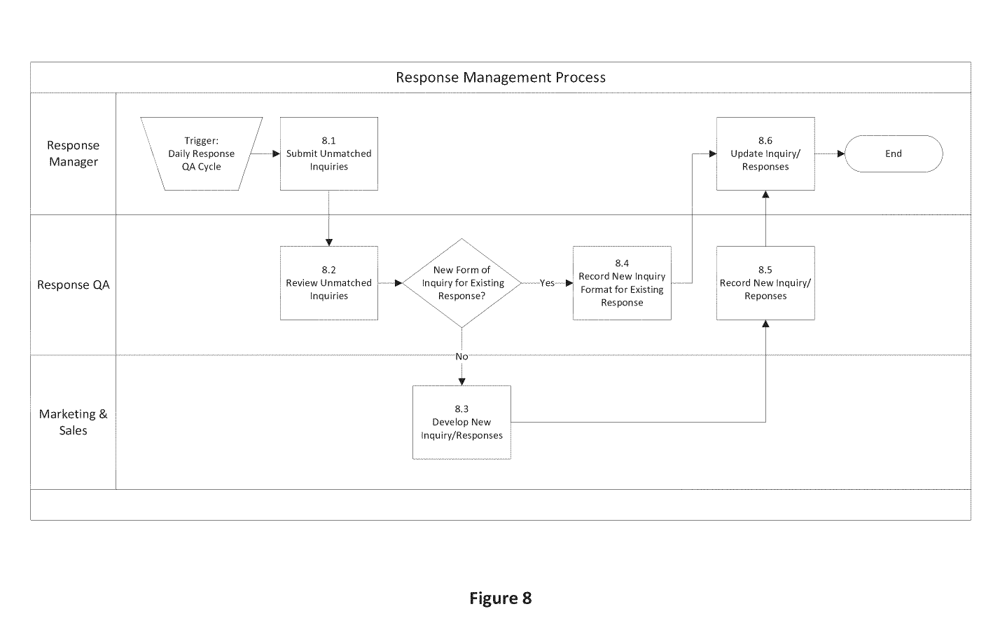

FIG. 8 is a swimlane diagram showing the communications interrelationships between the Response Manager functionality at a commercial establishment, the Response Quality Assurance role at the same commercial Establishment, and the Marketing/Sales organization at the same commercial Establishment. With respect to FIG. 8, the Response Manager notifies the Response QA group of prior period Unmatched Inquiries in Activity 8.1. These are Inquiries that had no corresponding Inquiry permutation in the Response Database. The Response QA group analyzes the Unmatched Inquiries in Activity 8.2 and determines whether a given Unmatched Inquiry is a new form of Inquiry for a Response currently in the Response Database, e.g., a new spelling or abbreviation for a word, or an entirely new Inquiry being made to the retail establishment.

If the Unmatched Inquiry is a new permutation for an Inquiry currently in the Response Database, the Response QA group records a new Inquiry Format in Activity 8.4 and submits it for update in Activity 8.6 by the Response Manager.

If the Unmatched Inquiry is an entirely new Inquiry (absent from, on nonexistent in, one or more of the databases in the system) being directed to the commercial establishment, a unit within that commercial establishment, such as their Marketing & Sales department, responsible for product strategy/pricing and relations with the customer base, develops one or more new sets of Inquiry/Response pairs in Activity 8.3 and submits those pairs to the Response QA group to record them in Activity 8.5. Once recorded in Activity 8.5, these new pairs are added to the Response Database in Activity 8.6.

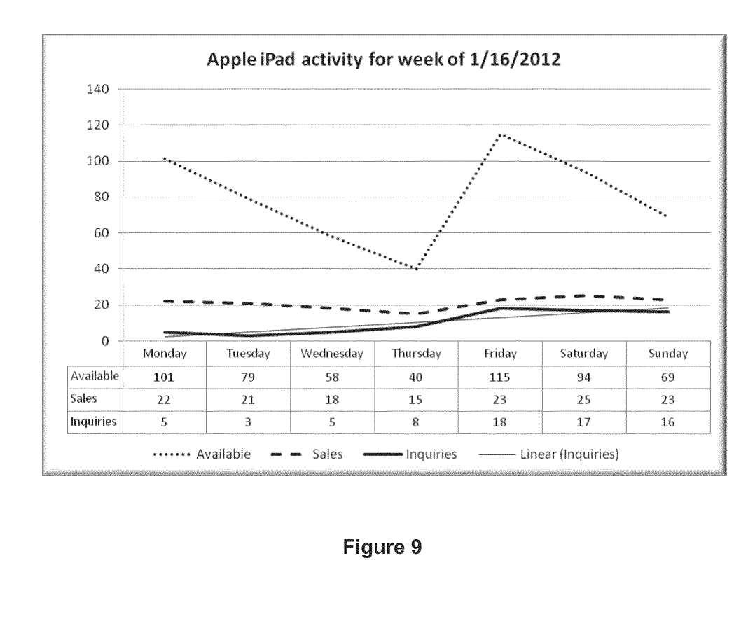

With respect to FIG. 9, data from inquiries regarding product availability is summarized along with actual sales and inventory in order to graphically illustrate customer patterns over a designated time period. Trend information for Inquiries is also charted. FIG. 9 thus shows an advantage of accruing marketability information with respect to one or more products by providing an SMS system adapted and arranged to respond to product availability inquiries and product pricing inquiries, and then analyzing the information gathered by that system with respect to those products. Analyses can be used for a plurality of purposes, including its use as a basis for adjusting the price, availability, and inventory of products.

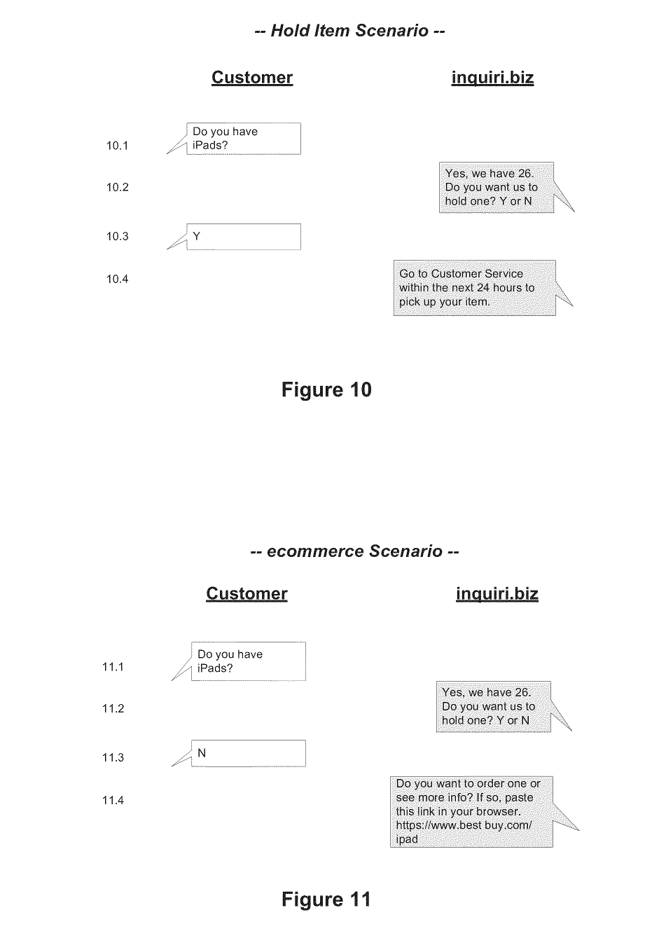

FIG. 10 shows exemplary SMS Communications in the context of the invention. As is shown in FIG. 10, a “Hold Item Scenario” means engaging in a sales negotiation by conducting a dialogue with a potential customer with respect to a product designated by an inquiry from that customer via an SMS system of the invention. In FIG. 10, the dialogue is directed toward determining whether the retailer should hold the subject item for the potential customer, for example, by physically transferring the item to a “will call” section of the retail location and occurs between the potential customer and a computer-facilitated entity.

With respect to FIG. 10, text message 10.1 is sent by the customer via an SMS application of the invention. In response, an SMS application of the invention responds to the inquiry by sending text message 10.2 after accessing the Inventory Database. In text message 10.3, the customer responds with their choice to the question posed by the SMS application. Upon receipt of this message, the application informs the customer through text message 10.4 of the need to pick the held item up within 24 hours. The application also can be adapted and arranged to decrement the inventory by one item, and notify customer service of the need to place the physical item on hold.

FIG. 11 illustrates an example, in the context of the invention, of an SMS Communication of the invention, an “ecommerce Scenario” which illustrates a sales negotiation by conducting a dialogue with a potential customer with respect to a product designated by an inquiry from that customer via an SMS system, wherein the dialogue is directed toward determining whether the customer would like to obtain more product information or order the product and occurs between the potential customer and the retailer website. With respect to FIG. 11, text message 11.1 is sent by the customer to the SMS application. In response, the application sends text message 11.2 after accessing the Inventory Database. In text message 11.3, the customer responds with their choice to the question posed. Upon receipt of this message, the application informs the customer through text message 11.4 that they may order the product or obtain more information by following the link supplied.

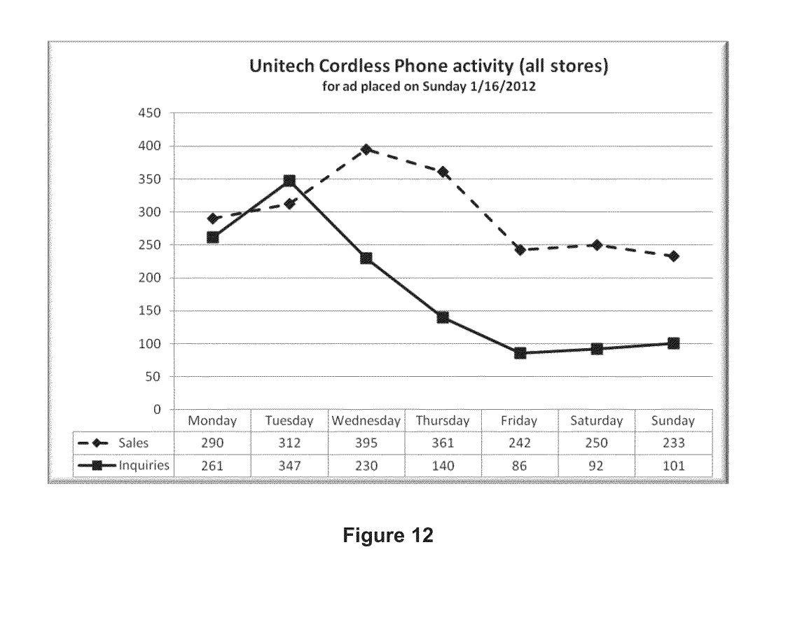

FIG. 12 comprises a graph depicting the affect of use of the methods of the present invention on patterns of customer inquiries and the resulting sales activity following mass media advertising for a product. With respect to FIG. 12, data from inquiries (red data points and red line) is summarized along with actual sales (blue data points and blue line) to graphically illustrate the advantageous affect of mass market advertising of a product over a designated time period. With respect to FIG. 12, the graph shows an increase in product sales following conventional media advertisement, and resulting in an increase in the interest in one or more products, or one or more commercial establishments, by advertising the availability of one or more products via conventional means, such as radio, television, and print media, and then encouraging inquiries via one or more SMS systems adapted and arranged to provide information about those products and establishments.

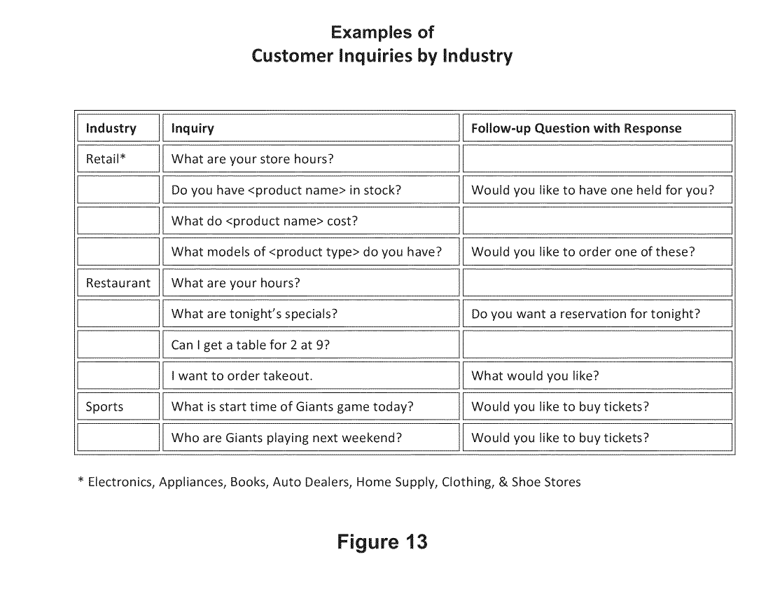

FIG. 13 shows representative examples of some embodiments of the business methods aspects of the invention being utilized to provide new communication channels between potential customers and one or more businesses via an SMS system. FIG. 13 is a table containing representative example, by industry, of some of the possible customer inquiries and follow-up questions included with response that can be facilitated by the invention.

With respect to FIG. 13, representative examples of some of the possible customer inquiries, are illustrated. In some embodiments, the responses can be linked to existing e:commerce sites in order to book the sale. For example, when a customer wants to reserve a table at a restaurant, the table reservation system can be linked to the present system in order to book it. The results of that activity can then be texted to the customer.

The invention can be utilized by companies (commercial entities) in these, and many other, industries by purchasing a license for the software and installing it within their IT infrastructure or by having their implementation hosted. Either of these choices, among many others, allows the company to administer their own data, e.g., updating the response database with any changes needed or desired.

### Objects and Additional Details of the Invention

As one of skill in the art will appreciate, there are therefore numerous uses and objects of the invention. For example, it is an object of the invention to provide methods and systems for use by both potential customer or buyers and enterprises to increase traffic to the enterprise stores and websites by SMS messaging systems and functionalities. It is also an object of the invention to monetize services provide by systems and methods of the invention. It is an additional object of the invention to gather and analyze many different kinds of data and information, and to utilize that data both historically and in real time.

In accordance with this and other objects of the invention, a method for increasing the marketability of products and for increasing commercial traffic to one or more commercial establishments is provided. In one embodiment, the method comprises the steps or actions of: A) communicating a text message inquiry from a sender via the sender's electronic device, wherein the inquiry is in the form of a text message inquiry, and wherein the text message inquiry is communicated to at least one server via at least one first communications network, B) providing the at least one server, wherein the at least one server is adapted and arranged to receive and respond to the text message inquiry, wherein the server is in operative communication with at least one response database, with at least one customer inquiry database and at least one inventory database, wherein the at least one server is adapted and arranged to provide at least one selectable response to the text message inquiry, and C. selecting and providing at least one selectable response to the text message inquiry from the sender, wherein the at least one response is provided to the sender's electronic device via at least one second communications network.

In some embodiments of the invention, the first communications network and the second communications network are the same. In other words, communications are effectively conducted in a loop in some embodiments. As another key aspect, the response database, the customer inquiry database and the inventory database are in operative communication with one another. This operative communication can be in any priority or in any manner as may be desirable depending upon the requirements of the context of the invention. For example, when the invention is adapted and arranged to be used in the context of high-speed merchandising, such as an electronics retail business, and the primary goal of the method is to gather marketing information, the priority of access of the databases might be to access the inventory database first, and then to access the customer inquiry database second and to access the response database.

In accordance with other objects and advantages of the invention, one or more of the response database comprises the catalog of selectable responses, wherein the selectable responses are adapted and arranged to correlate with one or more specific expected text message inquiries from one or more expected senders. For example, store hours information is provided in exactly the same format for any expected inquiry about when the store is open.

As yet another advantage, the methods of the invention may, further comprise the step or action of D) analyzing the text message inquiry in one or a plurality of ways to determine a set of possible responses to the inquiry, wherein at least one of the response database and the inventory database are searched for data relevant to the inquiry.

As a related advantage, the present methods may further comprise the step or action of E) selecting at least one first response from the set of selectable responses from the response database, to yield a selected at least one first response; and also the step or action of F) sending the selected at least one first response to the sender. As another key aspect, the methods of the invention may further comprise the step or action of G) sending a follow-on message to the sender when the sender does not reply to the selected at least one first response within a selected or predetermined time period. In a related advantage, the follow-on message to the sender may comprise a product promotion or offer, wherein the product promotion or offer is tailored to the initial text message inquiry or to information regarding the sender contained within the customer inquiry database.

As an additional key aspect, the methods of the invention may advantageously further comprising the step or action of H) receiving a first reply from the sender to the selected at least one first response to sent to the sender in Step F. Similarly, the methods of the invention may further comprise the step or action of I) receiving a first reply from the sender to the follow-on message, and the step or action of J) analyzing the first reply from the sender in one or a plurality of ways to determine a set of possible responses to the inquiry, wherein at least one of the response database and the inventory database are searched for data relevant to the first reply.

In accordance with still other aspects and advantages of the invention, the present methods may further comprise the step or action of K) analyzing the first reply from the sender in one or a plurality of ways to determine a set of possible responses to the inquiry, wherein at least one of the response database and the inventory database are searched for data relevant to the first reply. As a related key aspect for the present methods, the steps or actions of repeating one or more of any of the steps or actions of the present methods, such as Steps D, E, F, G, H, I, J and K, as needed to consummate a transaction with the sender may be affected in order to accomplish one or more functions of the invention as desired or needed.

As an additional advantageous aspect, the methods may include wherein the response database comprises a series of single selectable specific responses to a plurality of different expected text message inquiries. For example, a customer could be asking the question “When is the store open?” in a number of fashions. The following list is a set of expected inquiries that could be submitted by the customer:
Are you open?
R u open?
R you open?
R u open
R you open
When are u open?
When are you open?
When is the store open?

They are all answered with same response; a statement of the days and times the retail establishment is open for business.

As one of skill in the art can appreciate, the present methods and systems are affected in key primary aspects by software that is adapted and arranged to affect the steps, actions and ongoing operation of the present methods and systems. Thus, with respect to one or more of the response database and the inventory database comprises software means adapted and arranged to interpret the text message inquiry in one or a plurality of ways, and to provide at least one response to the text message inquiry.

The present methods and systems are also advantageous in that they are accumulative in nature, that is, in operation, they gather and record data from the collected inquiries and response in the customer inquiry database. Thus, the present methods may comprise the additional steps or actions of K), the at least one customer inquiry database and, to include data obtained from the text message inquiry and from any ensuing dialogue.

A significant function of the present invention is to match products with buyers via SMS messaging systems. Thus, in yet another important aspect, the inventory database may comprise one or more catalogs of products or services adapted and arranged in accordance with the commercial goals of the one or more commercial establishments.

Moreover, the present methods and systems enable the development of marketing strategies built to the order and specification of many particular businesses. Thus, the present methods and systems include wherein the inventory database comprises one or more catalogs of products or services adapted and arranged in accordance with the commercial goals of a specific commercial establishment.

Fallback or alternative steps, methods and systems are also included within the scope and spirit of the present invention. Thus, in the present methods, if an appropriate response is not contained in the response database, the sender is put in communication with a person, the inquiry is investigated or evaluated, one or more appropriate responses are provided to the sender, and one or more appropriate responses or related data are added to the response database.

In yet other advantages, the methods and systems of the present invention comprise wherein the methods and systems are adapted and arranged to integrate with other methods, wherein the other methods comprise SMS messaging functionalities. Those SMS functionalities are SMS centers (SMSCs) and Short Message Service (SMS) gateways. A SMSC is the portion of a carrier's wireless network that handles SMS operations, such as routing, forwarding and storing incoming text messages on their way to desired endpoints.

SMS gateways facilitate and streamline text messaging processes for organizations, and will often do some of the conversion to different formats utilized by different carriers. They can also provide a hosted messaging platform to SMS-enable any application, website or system. Thus, an incoming message can be passed from the SMS gateway to a website, processed by same, and a response subsequently handed back to the gateway to send to the message originator.

### Particular Embodiments of a System for Increasing Commercial Traffic by Way of SMS Messaging

In accordance with the many objects of the invention, an SMS messaging system is provided. A messaging system of the invention is adapted and arranged for one or more of increasing the marketability of products and increasing commercial traffic to one or more commercial establishments. In some embodiments, the system comprises A) at least one server, the at least one server configured to provide a Short Messaging Service (SMS) system, wherein the SMS system is configured for receiving and responding to one or more text message inquiries from one or more senders regarding one or more commercial businesses offering one or more products, and wherein the text message inquiries are sent from the sender via the sender's electronic device, B) at least one response database, wherein the at least one response database comprises at least one first library of selectable responses to expected inquiries likely to be received from the one or more senders, C) the internet infrastructure components required to enable internet communications, wherein the components are adapted and arranged for facilitating communications among the server, and the one or more senders, and D) Software operatively arranged within the SMS system, wherein the software is configured, or adapted and arranged, to affect one or more replies to the one or more of the inquiries by affecting one or more responses to each inquiry from the at least one first response database, wherein the one or more responses comprise at least one selectable response.

In another key aspect, a system of the invention may further comprise at least one customer inquiry database and at least one inventory database, and wherein the response database, the customer inquiry database and the inventory database are in operative communication with one another.

In an advantageous aspect, a system the invention may include wherein one or more of the response database and the customer inquiry database comprises at least one catalog or library of selectable responses, wherein the selectable responses are adapted and arranged to correlate with one or more specific expected text message inquiries.

As an additional advantage, the system can be configured to perform the step or action of D, analyzing the text message inquiry in one or a plurality of ways to determine a set of possible responses to the inquiry from the sender, wherein at least one of the response database, the customer inquiry database and the inventory database are searched for data relevant to the inquiry. As one of skill in the art will appreciate, numerous iterations of the dialogues referred to herein by one or many senders, and with reference to one or many enterprise establishments, can be accomplished by the systems and methods of the invention.

In a similarly advantageous manner, a system of the invention may comprise wherein the system is configured to perform the step or action of E, selecting at least one first response from the set of selectable responses from the response database, to yield a selected at least one first response, as well as the further step of F, sending the selected at least one first response to the sender to thereby answer the inquiry or to continue a dialogue with the sender.

A system of the invention may also include wherein the system is configured to perform the step or action of G, sending a follow-on message to the sender when the sender does not reply to the selected at least one first response within a selected or predetermined time period. Moreover, the follow-on message to the sender comprises a product promotion or offer, wherein the product promotion or offer is tailored to the initial text message inquiry.

In another positive aspect, s system of the present invention may comprise wherein the system is configured to perform the step or action of H, receiving a first reply from the sender to the selected at least one first response sent to the sender in Step F, as well as wherein the step or action of I, receiving a first reply from the sender to the follow-on message. Of course, the dialogue can be continued for many cycles or iterations in a similar manner in the context of many of the embodiments of the systems and method of the invention.

In accordance with yet other objects of the invention, a system of the invention can be configured to perform the step or action of J, analyzing the first reply from the sender in one or a plurality of ways to determine a set of possible responses to the inquiry, wherein at least one of the response database and the inventory database are searched for data relevant to the first reply.

In a similar manner, particular embodiments of the present system may be configured to perform the step or action of K, analyzing the first reply from the sender in one or a plurality of ways to determine a set of possible responses to the inquiry, wherein at least one of the response database and the inventory database are searched for data relevant to the first reply.

In a significant aspect, the present systems and methods are adapted and arranged to repeat process or method steps in order to achieve various goals, such as that of satisfying sender inquiries, promoting the sale of various products and services, and the gathering or collecting of various types of data for use in marketing and promotional activities. Thus, a system of the invention can be configured to perform repeatedly any of its steps or actions, for example, the steps or actions of Steps D, E, F, G, H, I, J and K as needed to consummate a transaction with the sender, or to gather data, or to achieve any other goal or purpose of the present system and methods.

In yet other significant aspects, the present methods and systems provide one or more libraries, catalogs or lists of possible or likely responses to many of the inquiries likely to be sent or forwarded by a sender. In one aspect of this feature, the response database comprises a series of single selectable specific responses to a plurality of different text message inquiries. Thus, one response from the response database can often be used in reply to several or many inquiries.

In a similar fashion, one or more of the response database and the inventory database operates with software adapted to interpret the text message inquiry in one or a plurality of ways, and to provide at least one response to the text message inquiry.

As another key aspect of the systems and methods of the invention, data is gathered, organized or collected such that the system accrues information regarding products, as examples, potential customers (senders), competition between or among various products or services. Thus, a system of the invention will perform the step or action of N, modifying one or more of the at least one response database, the at least one customer inquiry database and the at least one inventory database, to include data obtained from the text message inquiry and from any ensuing dialogue or communications.

As yet an additional key aspect, some embodiments of the present system include wherein the inventory database comprises one or more catalogs of products or services adapted and arranged in accordance with the commercial goals of the one or more commercial establishments, or in accordance with the commercial goals of a specific commercial establishment.

As an additional positive characteristic, the present system includes steps or actions whereby an inquiry is answered regardless of the present status of the various databases. In this aspect, if an appropriate response is not contained in the response database, the system is configured such that any one or more of the following actions may ensue: the sender is put in communication with a person, the inquiry is investigated or evaluated, one or more appropriate responses are provided to the sender, and one or more appropriate responses or related data are added to the response database. As yet another key characteristic, the present systems and methods are adaptable and arrangeable to integrate with other systems, such as systems which comprise one or more SMS messaging functionalities.

In accordance with some key advantageous and objects of the invention, a method for gathering data and for monetizing the promotional and interactive functionalities of an SMS messaging system with respect to commercial enterprises, is provided. In some embodiments, the method comprises the steps or actions of A) providing at least one SMS messaging system configured for increasing the marketability of one or more of the products and services with respect to one or more commercial establishments, and for gathering marketing and performance data useful for one or more of evaluating, adapting and configuring marketing and other commercial efforts, the system comprising: i) at least one server, the at least one server configured to provide a Short Messaging Service (SMS) system, wherein the SMS system is configured for receiving and responding to one or more text message inquiries from one or more senders regarding one or more commercial businesses offering one or more products, and wherein the text message inquiries are sent from the sender via the sender's electronic device, ii) at least one response database, wherein the at least one response database comprises at least one catalog of selectable responses to expected inquiries likely to be received from the one or more senders, iii) Internet infrastructure components sufficient to enable internet communications, wherein the components are adapted and arranged for facilitating communications among the server and the one or more senders, iv) software operatively arranged within the SMS system, wherein the software is configured to affect one or more replies to the one or more of the inquiries by affecting one or more responses to each inquiry from the at least one first response database, wherein the one or more responses comprise at least one selectable response, and v) software and hardware configured for gathering and storing the inquiries, the responses, and any other data obtainable from communications within the system; B gathering from the SMS messaging system marketing and performance data, C) providing one or more services with respect to the operation of the one or more SMS messaging systems, and with respect to the marketing and performance data gathered by the systems to create one or more provided services, and D) receiving payment for the provided services.

In a key aspect, the method may include wherein the system further comprises at least one customer inquiry database and at least one inventory database, and wherein the response database, the customer inquiry database and the inventory database are in operative communication with one another such that data from the communications associated with the system can be gathered, organized, mined and analyzed. In a related manner, the method includes wherein one or more of the response database and the customer inquiry database comprises at least one catalog of selectable responses, wherein the selectable responses are adapted and arranged to correlate with one or more specific expected text message inquiries.

In yet another advantage, the present method can comprise wherein the system is configured to perform one or more of the steps or actions of a. analyzing the text message inquiry in one or a plurality of ways to determine a set of possible responses to the inquiry, wherein at least one of the response database, and the inventory database are searched for data relevant to the inquiry; b. selecting at least one first response from the set of selectable responses from the response database, to yield a selected at least one first response; c. sending the selected at least one first response to the sender; d. sending a follow-on message to the sender when the sender does not reply to the selected at least one first response within a selected or predetermined time period; e. receiving a first reply from the sender to the selected at least one first response sent to the sender in Step d; f. receiving a first reply from the sender to the follow-on message; g. analyzing the first reply from the sender in one or a plurality of ways to determine a set of possible responses to the inquiry, wherein at least one of the response database and the inventory database are searched for data relevant to the first reply; h. analyzing the first reply from the sender in one or a plurality of ways to determine a set of possible responses to the inquiry, wherein at least one of the response database and the inventory database are searched for data relevant to the first reply; i. repeating one or more of Steps D, E, F, G, H, I, J, K, L and M as needed or desired to consummate a transaction with the sender, and j. repeating one or more of Steps D, E, F, G, H, I, J, K, L and M as needed or desired to gather additional data with respect to the sender, the transaction or the marketing efforts.

The present methods include also wherein one or more the functions, steps or actions of the system are occurring in real time. In another aspect, the Internet infrastructure components to be used with the present methods are one or more from the list comprising routers, hubs, switches, communication lines, Domain Name Systems (DNS), Internet Service Providers, and any other hardware or software components necessary or desirable for affecting any of the functions or goals of the invention.

In yet another key advantageous aspect, the methods of the invention provides numerous ways for providing services, and for levying charges or payments for those services. In the context of the invention, the terminology “for payment” means that the services or products provided by the methods and systems of the invention are provided for money, or other means of exchange, such as for the exchange of services, the exchange of products.

Thus, in one aspect, the SMS messaging methods of the invention is configured for providing one or more of the following services in exchange for payment: offering a sponsored product as an alternative to a requested product during an inquiry response dialogue with a sender; incentivizing commercial businesses to provide “sale” items via the system; providing incentives to product owners and marketers using the system, such as marketing data analyses, incentive points and special features vis-à-vis push marketing of specific products via a system and methods of the invention; based upon data gathered by a system of the invention, offering special promotions based upon competitive marketing with respect to two or more products; providing special offers, advertising or promotions with respect to preferred products of users of a system; providing special offers, advertising or promotions with respect to specific manufacturers or producers; and providing incentives to senders or users of the system, such as discounts, incentive points and special offers.

In a related key aspect, the SMS messaging methods of the invention are configured for providing one or more of the following in exchange for payment: using data collected by a system of the invention to perform one or more market analyses with respect to one or more products, or with respect to one or more featured products; providing one or more market analyses to third parties or to product sellers or to marketing companies for value; providing feedback marketing analyses with respect to any marketing or promotional activity vis-à-vis a system of the invention; providing marketing data analyses as incentives to product owners and marketers using the system, wherein the incentives comprise incentive points and special features vis-à-vis push marketing of specific products via systems and methods of the invention.

Similarly, the SMS messaging methods of the invention can also be configured for providing one or more of the following in exchange for payment: monitoring the performance of one or more sales campaigns with respect to recent advertising or promotional efforts for selected products to obtain performance data, and then altering the advertising in view of the performance data or in view of the requirements or instructions of one or more users; monitoring the performance of designated products with respect to inventory, and with respect to what proportion of “hold” products are ultimately purchased; and providing real time monitoring to obtain information sufficient such that a commercial business can make marketing decisions in real time based upon the data gathered; and monitoring price sensitivity with respect to similar products in the inventory of the commercial entity, and then, altering the advertising in view of the performance data.

In a related advantageous aspect, SMS messaging methods of the invention is configured for providing one or more of the following in exchange for payment: providing “hold” services whereby a potential customer pays a fee in return for the commercial business holding an item for a specific length of time for that potential customer; coordinating communications between the retailer and the supplier of any products, or of targeted products; providing the hardware and software, such as a server, adapted and arranged to affect the methods of a system of the invention, providing a turnkey system adapted and arranged to market the products or services of a specific business enterprise; providing a Smartphone app configured for communication with a system of the invention; and providing a connection between an online payment service or system, and the commercial enterprise or business.

Moreover, the present methods include wherein the SMS messaging system is adapted and arranged to reside within one portable digital device, and wherein the portable device is adapted and arranged to perform any of the steps of the methods of the invention.

In accordance with further objects of the invention, an interactive SMS messaging system useful for promoting product and services is provided. In some embodiments of the invention, an SMS messaging system is adapted and arranged for increasing the marketability of the products and services with respect to one or more commercial establishments, and for gathering marketing and performance data useful for one or more of evaluating, adapting and configuring marketing and other commercial efforts, the system comprising: A) at least one server, the at least one server configured to provide a Short Messaging Service (SMS) system, wherein the SMS system is configured for receiving and responding to one or more text message inquiries from one or more senders regarding one or more commercial businesses offering one or more products, and wherein the text message inquiries are sent from the sender via the sender's electronic device, B) at least one response database, wherein the at least one response database comprises at least one catalog of selectable responses to expected inquiries likely to be received from the one or more senders, C) Internet infrastructure components sufficient to enable internet communications, wherein the components are adapted and arranged for facilitating communications among the server and the one or more senders, D) software operatively arranged within the SMS system, wherein the software is configured to affect one or more replies to the one or more of the inquiries by affecting one or more responses to each inquiry from the at least one first response database, wherein the one or more responses comprise at least one selectable response, and E) software and hardware configured for gathering and storing the inquiries, the responses, and any other data obtainable from communications within the system.

In one advantageous aspect, a system of the invention may further comprise at least one customer inquiry database and at least one inventory database, and wherein the response database, the customer inquiry database and the inventory database are in operative communication with one another such that data from the communications associated with the system can be gathered, organized, mined and analyzed. In a related aspect, the system includes wherein one or more of the response database and the customer inquiry database comprises at least one catalog of selectable responses, wherein the selectable responses are adapted and arranged to correlate with one or more specific expected text message inquiries.

In yet another advantageous aspect, a system of the invention can be configured to perform one or more of the steps or actions of a. analyzing the text message inquiry in one or a plurality of ways to determine a set of possible responses to the inquiry, wherein at least one of the response database, and the inventory database are searched for data relevant to the inquiry; b. selecting at least one first response from the set of selectable responses from the response database, to yield a selected at least one first response; c. sending the selected at least one first response to the sender; d. sending a follow-on message to the sender when the sender does not reply to the selected at least one first response within a selected or predetermined time period; e. receiving a first reply from the sender to the selected at least one first response sent to the sender in Step d; f. receiving a first reply from the sender to the follow-on message; g. analyzing the first reply from the sender in one or a plurality of ways to determine a set of possible responses to the inquiry, wherein at least one of the response database and the inventory database are searched for data relevant to the first reply; h. analyzing the first reply from the sender in one or a plurality of ways to determine a set of possible responses to the inquiry, wherein at least one of the response database and the inventory database are searched for data relevant to the first reply; i. repeating one or more of Steps D, E, F, G, H, I, J, K, L, and M as needed or desired to consummate a transaction with the sender, and j. repeating one or more of Steps D, E, F, G, H, I, J, K, L, and M as needed or desired to gather additional data with respect to the sender, the transaction or the marketing efforts.

As a particularly advantageous feature, a system of the invention can comprise wherein one or more the functions, steps or actions of the system are occurring in real time. In another aspect, the Internet infrastructure components are one or more from the list comprising routers, hubs, switches, communication lines, Domain Name Systems (DNS), Internet Service Providers, and any other hardware or software components necessary or desirable for affecting any of the functions or goals of the invention.

In yet another key advantageous aspect, the invention provides numerous ways for providing services, and for levying charges or payments for those services. In the context of the invention, the terminology “for payment” means that the services or products provided by the methods and systems of the invention are provided for money, or other means of exchange, such as for the exchange of services, the exchange of products.

Thus, in one aspect, an SMS messaging system of the invention is configured for providing one or more of the following services in exchange for payment: offering a sponsored product as an alternative to a requested product during an inquiry response dialogue with a sender; incentivizing commercial businesses to provide “sale” items via the system; providing incentives to product owners and marketers using the system, such as marketing data analyses, incentive points and special features vis-à-vis push marketing of specific products via a system and methods of the invention; based upon data gathered by a system of the invention, offering special promotions based upon competitive marketing with respect to two or more products; providing special offers, advertising or promotions with respect to preferred products of users of a system; providing special offers, advertising or promotions with respect to specific manufacturers or producers; and providing incentives to senders or users of the system, such as discounts, incentive points and specials.

In a related key aspect, an SMS messaging system of the invention is configured for providing one or more of the following in exchange for payment: using data collected by a system of the invention to perform one or more market analyses with respect to one or more products, or with respect to one or more featured products; providing one or more market analyses to third parties or to product sellers or to marketing companies for value; providing feedback marketing analyses with respect to any marketing or promotional activity vis-à-vis a system of the invention; providing marketing data analyses as incentives to product owners and marketers using the system, wherein the incentives comprise incentive points and special features vis-à-vis push marketing of specific products via systems and methods of the invention.

Similarly, an SMS messaging system of the invention can also be configured for providing one or more of the following in exchange for payment: monitoring the performance of one or more sales campaigns with respect to recent advertising or promotional efforts for selected products to obtain performance data, and then altering the advertising in view of the performance data or in view of the requirements or instructions of one or more users; monitoring the performance of designated products with respect to inventory, and with respect to what proportion of “hold” products are ultimately purchased; and providing real time monitoring to obtain information sufficient such that a commercial business can make marketing decisions in real time based upon the data gathered; and monitoring price sensitivity with respect to similar products in the inventory of the commercial entity, and then, altering the advertising in view of the performance data.

In a related advantageous aspect, an SMS messaging system of the invention is configured for providing one or more of the following in exchange for payment: providing “hold” services whereby a potential customer pays a fee in return for the commercial business holding an item for a specific length of time for that potential customer; coordinating communications between the retailer and the supplier of any products, or of targeted products; providing the hardware and software, such as a server, adapted and arranged to affect the methods of a system of the invention, providing a turnkey system adapted and arranged to market the products or services of a specific business enterprise; providing a Smartphone app configured for communication with a system of the invention; and providing a connection between an online payment service or system, and the commercial enterprise or business.

Moreover, the present systems include wherein the SMS messaging system is adapted and arranged to reside within one portable digital device, and wherein the portable device is adapted and arranged to perform any of the steps of the methods of the invention.

The foregoing detailed description has set forth various embodiments of the methods, systems, devices or processes via the use of flowcharts, diagrams, figures or examples. Insofar as such flowcharts, diagrams, figures or examples contain one or more functions or operations, it will be understood by those within the art that each function or operation within such flowchart, diagram, figure or example can be implemented, individually or collectively, by a wide range of any combination thereof.

One skilled in the art will recognize that the herein described components (e.g., steps), devices, and objects and the discussion accompanying them are used as examples for the sake of conceptual clarity and that various configuration modifications are within the skill of those in the art. Consequently, as used herein, the specific exemplars set forth and the accompanying discussion are intended to be representative of their more general classes. In general, use of any specific exemplar herein is also intended to be representative of its class, and the non-inclusion of such specific components (e.g., steps), devices, and objects herein should not be taken as indicating that limitation is desired.

The herein described subject matter sometimes illustrates different components contained within, or connected with, different other components. It is to be understood that such depicted figures are merely exemplary, and that in fact many other figures can be implemented which achieve the same functionality. In a conceptual sense, any arrangement of components to achieve the same functionality is effectively “associated” or “coupled” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” operatively connected,” or “operably coupled”, to each other to achieve the desired functionality, and any two components capable of being so associated can also be viewed as being “operably couplable,” to each other to achieve the desired functionality. Specific examples of operably couplable include but are not limited to, physically mateable or physically interacting components or wirelessly interactable or wirelessly interacting components or logically interacting or logically interactable components.

In a general sense, those skilled in the art will recognize that the various aspects described herein which can be implemented, individually or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes or devices described herein, or a microprocessor configured by a computer program which at least partially carries out processes or devices described herein), electrical circuitry forming a memory device (e.g., forms of random access memory), or electrical circuitry forming a communications device (e.g., a modem, communications switch, or optical-electrical equipment). Those having skill in the art will recognize that the subject matter described herein may be implemented in an analog or digital fashion or some combination thereof.

Those skilled in the art will recognize that it is common within the art to describe devices or processes in the fashion set forth herein, and thereafter use engineering practices to integrate such described devices or processes into image processing systems. That is, at least a portion of the devices or processes described herein can be integrated into an image processing system via a reasonable amount of experimentation. Those having skill in the art will recognize that a typical image processing system generally includes one or more of a system unit housing, a video display device, a memory such as volatile and non-volatile memory, processors such as microprocessors and digital signal processors, computational entities such as operating systems, drivers, and applications programs, one or more interaction devices, such as a touch pad or screen, control systems including feedback loops and control motors (e.g., feedback for sensing lens position or velocity; control motors for moving/distorting lenses to give desired focuses). A typical image processing system may be implemented utilizing any suitable commercially available components, such as those typically found in digital still systems or digital motion systems.

One skilled in the art will recognize that the herein described components (e.g., steps), devices, and objects and the discussion accompanying them are used as examples for the sake of conceptual clarity and that various configuration modifications are within the skill of those in the art. Consequently, as used herein, the specific exemplars set forth and the accompanying discussion are intended to be representative of their more general classes. In general, use of any specific exemplar herein is also intended to be representative of its class, and the non-inclusion of such specific components (e.g., steps), devices, and objects herein should not be taken as indicating that a limitation is desired. Moreover, the steps of the methods described herein may be performed in specific sequences other than those exemplified herein.

With respect to the use of substantially any plural or singular terms herein, those having skill in the art can translate from the plural to the singular or from the singular to the plural as is appropriate to the context or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “operably coupled” or “coupled” or “in communication with” or “communicates with” or “operatively communicate” such other objects that the desired functionality is achieved. Hence, any two components herein combined to achieve a particular functionality can be seen as associated with each other such that the desired functionality is achieved, irrespective of architectures or intermedial components. Likewise, any two components so associated can also be viewed as being “connected”, or “attached”, to each other to achieve the desired functionality, and any two components capable of being so associated can also be viewed as being “operably couplable”, to each other to achieve the desired functionality.

While particular aspects of the present subject matter described herein have been shown and described, it will be apparent to those skilled in the art that, based upon the embodiments herein, changes and modifications may be made without departing from the subject matter described herein and its broader aspects and, therefore, any later-filed claims are to encompass within their scope all such changes and modifications as are within the true spirit and scope of the subject matter described herein. Furthermore, it is to be understood that the invention is defined both by the present disclosure and by any later-filed claims. It will be understood by those within the art that, in general, terms used herein, and especially in any later-filed claims (e.g., bodies of those claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the later-filed claim, and in the absence of such recitation no such intent is present.

For example, as an aid to understanding, any later-filed claims may contain usage of the introductory phrases “at least one” and “one or more” to introduce later-filed claim recitations. However, the use of such phrases should not be construed to imply that the introduction of a claim recitation by the indefinite articles “a” or “an” limits any particular later-filed claim containing such introduced claim recitation to inventions containing only one such recitation, even when the same claim includes the introductory phrases “one or more” or “at least one” and indefinite articles such as “a” or “an” (e.g., “a” or “an” should typically be interpreted to mean “at least one” or “one or more”); the same holds true for the use of definite articles used to introduce claim recitations. In addition, even if a specific number of an introduced in the later-filed claims, recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, or A, B, and C together, etc.). It will be further understood by those within the art that virtually any disjunctive word or phrase presenting two or more alternative terms, whether in the description, later-filed claims, or drawings, should be understood to contemplate the possibilities of including one of the terms, either of the terms, or both terms. For example, the phrase “A or B” will be understood to include the possibilities of “A” or “B” or “A and B.

What is claimed is:

1) A method for increasing the marketability of products and for increasing commercial traffic to one or more commercial establishments, wherein the method comprises the steps or actions of:
A. communicating a text message inquiry from a sender via the sender's electronic device, wherein the inquiry is in the form of a text message inquiry, and wherein the text message inquiry is communicated to at least one server via at least one first communications network,
B. providing the at least one server, wherein the at least one server is adapted and arranged to receive and respond to the text message inquiry,
wherein the server is in operative communication with at least one response database, with at least one customer inquiry database and at least one inventory database,
wherein the at least one server is adapted and arranged to provide at least one selectable response to the text message inquiry, and
C. selecting and providing at least one selectable response to the text message inquiry from the sender, wherein the at least one response is provided to the sender's electronic device via at least one second communications network.

2) The method of claim 1, wherein the first communications network and the second communications network are the same network.

3) The method of claim 1, wherein the response database, the customer inquiry database and the inventory database are in operative communication with one another.

4) The method of claim 1, wherein one or more of the response database and the customer inquiry database comprises at least one catalog of selectable responses, wherein the selectable responses are adapted and arranged to correlate with one or more specific expected text message inquiries.

5) The method of claim 1, further comprising the steps or actions of
D. analyzing the text message inquiry in one or a plurality of ways to determine a set of possible responses to the inquiry, wherein at least one of the response database, the customer inquiry database and the inventory database are searched for data relevant to the inquiry, and then
E. selecting at least one first response from the set of selectable responses from the response database, to yield a selected at least one first response, and then
F. sending the selected at least one first response to the sender.

6) The method of claim 5, further comprising the step or action of
G. sending a follow-on message to the sender when the sender does not reply to the selected at least one first response within a selected or predetermined time period, wherein the follow-on message to the sender comprises a product promotion or offer, wherein the product promotion or offer is tailored to the initial text message inquiry.

7) The method of claim 6, further comprising the step or action of
H. receiving a first reply from the sender to the selected at least one first response to sent to the sender in Step F.

8) The method of claim 8, further comprising the step or action of
I. receiving a first reply from the sender to the follow-on message.

9) The method of claim 8, further comprising the step or action of
J. analyzing the first reply from the sender in one or a plurality of ways to determine a set of possible responses to the inquiry, wherein at least one of the response database and the inventory database are searched for data relevant to the first reply.

10) The method of claim 1, further comprising the step or action of
K. repeating one or more of Steps D, E, F, G, H, I and J as needed to consummate a transaction with the sender.

11) The method of claim 4, wherein the response database comprises a series of single selectable specific responses to a plurality of different text message inquiries.

12) The method of claim 5, wherein one or more of the response database, the inventory database and the customer inquiry database comprises software means adapted and arranged to interpret the text message inquiry in one or a plurality of ways, and to provide at least one response to the text message inquiry.

13) The method of claim 1, further comprising the step or action of
L. modifying one or more of the at least one response database, the at least one customer inquiry database and the at least one inventory database, to include data obtained from the text message inquiry and from any ensuing dialogue.

14) The method of claim 1, wherein the inventory database comprises one or more catalogs of products or services adapted and arranged in accordance with the commercial goals of the one or more commercial establishments.

15) The method of claim 1, wherein if an appropriate response is not contained in the response database, the sender is put in communication with a person, the inquiry is investigated or evaluated, one or more appropriate responses are provided to the sender, and one or more appropriate responses or related data are added to the response database.

16) The method of claim 1, wherein the method is adapted and arranged to integrate with other methods, wherein the other methods comprise SMS messaging functionalities.

17) An SMS messaging system adapted and arranged for one or more of increasing the marketability of products and increasing commercial traffic to one or more commercial establishments, the system comprising:
A) at least one server, the at least one server configured to provide a Short Messaging Service (SMS) system, wherein the SMS system is configured for receiving and responding to one or more text message inquiries from one or more senders regarding one or more commercial businesses offering one or more products, and wherein the text message inquiries are sent from the sender via the sender's electronic device,
B) at least one response database, wherein the at least one response database comprises at least one first library of selectable responses to expected inquiries likely to be received from the one or more senders,
C) Internet infrastructure components sufficient to enable internet communications, wherein the components are adapted and arranged for facilitating communications among the server and the one or more senders, and
D) Software operatively arranged within the SMS system, wherein the software is adapted and arranged to effect one or more replies to the one or more of the inquiries by effecting one or more responses to each inquiry from the at least one first response database, wherein the one or more responses comprise at least one selectable response.

18) The system of claim 17, further comprising at least one customer inquiry database and at least one inventory database, and wherein the response database, the customer inquiry database and the inventory database are in operative communication with one another, and wherein one or more of the response database and the customer inquiry database comprises at least one catalog of selectable responses, wherein the selectable responses are adapted and arranged to correlate with one or more specific expected text message inquiries.

19) The system of claim 18, wherein the system is configured to perform the step or action of
E. analyzing the text message inquiry in one or a plurality of ways to determine a set of possible responses to the inquiry, wherein at least one of the response database, the customer inquiry database and the inventory database are searched for data relevant to the inquiry.

20) The system of claim 18, wherein the system is configured to perform the steps or actions of
F. selecting at least one first response from the set of selectable responses from the response database, to yield a selected at least one first response,
and wherein the system is further configured to perform the step or action of
G. sending the selected at least one first response to the sender.

21) The system of claim 20, wherein the system is configured to perform the step or action of
H. sending a follow-on message to the sender when the sender does not reply to the selected at least one first response within a selected or predetermined time period.

22) The system of claim 21, wherein the follow-on message to the sender comprises a product promotion or offer, wherein the product promotion or offer is tailored to the initial text message inquiry.

23) The system of claim 21, wherein the system is configured to perform the steps or actions of
I. receiving a first reply from the sender to the selected at least one first response sent to the sender in Step F, and
J. receiving a first reply from the sender to the follow-on message, and
K. analyzing the first reply from the sender in one or a plurality of ways to determine a set of possible responses to the inquiry, wherein at least one of the response database and the inventory database are searched for data relevant to the first reply.

24) The system of claim 22, wherein the system is configured to perform the steps or actions of
L. analyzing the first reply from the sender in one or a plurality of ways to determine a set of possible responses to the inquiry, wherein at least one of the response database and the inventory database are searched for data relevant to the first reply, and
M. repeating one or more of Steps D, E, F, G, H, I, J, K and L as needed to consummate a transaction with the sender.

25) The system of claim 17, wherein the response database comprises a series of single selectable specific responses to a plurality of different text message inquiries, and wherein one or more of the response database, the inventory database and the customer inquiry database comprises software means adapted and arranged to interpret the text message inquiry in one or a plurality of ways, and to provide at least one response to the text message inquiry.

26) The system of claim 17, wherein the system is configured to perform the step or action of
N. modifying one or more of the at least one response database, the at least one customer inquiry database and the at least one inventory database, to include data obtained from the text message inquiry and from any ensuing dialogue.

27) The system of claim 17, wherein the inventory database comprises one or more catalogs of products or services adapted and arranged in accordance with the commercial goals of the one or more commercial establishments, or in accordance with the commercial goals of a specific commercial establishment, and wherein,
if an appropriate response is not contained in the response database, the system is configured such that any one or more of the following actions may ensue: the inquiry is investigated or evaluated, one or more appropriate responses are provided to the sender, and one or more appropriate responses or related data are added to the response database.

28) The system of claim 17, wherein the system is adapted and arranged to integrate with other systems, wherein the other systems comprise SMS messaging functionalities.

29) A software application adapted and arranged to effect one or a plurality of the actions or steps of the method of the invention.
